(19) United States
(12) Patent Application Publication
(10) Pub. No.: US 2006/0077806 A1
(43) Pub. Date: Apr. 13, 2006

(54) Focus point calibration for optimum recording quality

(75) Inventors: Jin-Chuan Hsu, Hsin-Chu City (TW); Ching-Ning Chiu, Hsin-Chu City (TW)

Correspondence Address: TROXELL LAW OFFICE PLLC, Suite 1404, 5205 Leesburg Pike, Falls Church, VA, 22041, US

(73) Assignee: MediaTek Inc.

(21) Appl. No.: 11/289,468

(22) Filed: Nov. 30, 2005

Related U.S. Application Data
(62) Division of application No. 10/419,134, filed on Apr. 21, 2003.

(30) Foreign Application Priority Data
Oct. 29, 2002 (TW) 091132117

(51) Int. Cl. G11B 7/00

(52) U.S. Cl. 369/44.27; 369/53.1; 369/124.01

(57) ABSTRACT

The present invention provides a method for calibrating focus positions of a pickup head. The pickup head is in a focus position of a predetermined distance from an optical recording medium for producing a recording light beam of a predetermined power for recording corresponding data onto the optical recording medium. A predetermined position adjustment procedure is performed to adjust the focus position of the pickup head during data recording. The procedure comprises the steps of sensing a reflected light beam from the optical recording medium by means of a sensor to generate a corresponding write RF signal; searching an extreme value of the write RF signal and obtain a target focus position corresponding to the searched extreme value; and adjusting the pickup head to the target focus position, so as to enable further data recording onto the optical recording medium by the pickup head in the target focus position.

### BACKGROUND OF THE INVENTION

1. Field of the Invention

The present invention relates to a calibration method and a calibration system for, calibrating focus positions of a pickup head, and more particularly, to a calibration method and a calibration system for calibrating focus positions of a pickup head used in an optical recording/reproducing device.

2. Description of the Prior Art

In a conventional optical recording/reproducing device, the pickup head is in a focus position with a predetermined distance from an optical recording medium, and the predetermined focus position of the pickup head with respect to the optical recording medium defines a focus error zero-crossing (FEZC).

In a prior art method for calibrating focus positions of the pickup head, it is for calibrating the optimum focus position for data reproducing to ensure data reproducing quality.

According to the prior art, when recording data onto an optical medium, the pickup head records data in the focus position of the focus error zero-crossing. However, this predetermined focus position may not be the optimum focus position. The pickup head may be too far away from or closed to the optical recording medium, resulting in unstable recording quality of the optical recording medium. Such optical recording medium with unstable recording quality may further impact data reproducing quality.

### SUMMARY OF THE INVENTION

The objective of the present invention is to provide a calibration method and a calibration system for calibrating focus positions of a pickup head and to effectively solve the problems of unstable recording/reproducing quality in the prior art.

According to a preferred embodiment, the present invention provides a calibration method for calibrating focus positions of a pickup head. The pickup head is in a focus position of the focus error zero-crossing for producing a recording light beam of a predetermined power for recording corresponding data onto the optical recording medium. While the calibration method is performed, a predetermined position adjustment procedure is utilized to adjust the focus position of the pickup head during data recording, and a reflected light beam from the optical recording medium is sensed by means of a sensor to generate a corresponding write RF signal. Next, an extreme value of the write RF signal is searched to obtain a target focus position corresponding to the searched extreme value of the write RF signal. Then, the pickup head is adjusted to the target focus position, so as to enable further data recording onto the optical recording medium by the pickup head in the target focus position.

The calibration method of the present invention calibrates focus positions of a pickup head before data recording, so as to search for the extreme value of the write RF signal and hence to find the optimum focus position of the pickup head, which can ensure stable recording quality and tolerate more focus error.

The objective of the present invention will no doubt become obvious to those of ordinary skill in the art after reading the following detailed description of the preferred embodiment, which is illustrated in the various figures and drawings.

### BRIEF DESCRIPTION OF THE DRAWINGS

FIG. 1 is a schematic diagram of a calibration system for calibrating focus positions of a pickup head and an optical recording medium according to the present invention.

FIG. 2 is a schematic diagram of the write RF signals in the procedure of recording data onto the optical recording medium when the pickup head shown in FIG. 1 is in a specific focal distance.

FIG. 3 shows a curve of corresponding B level in accordance with different focus offset values in the calibration system shown on FIG. 1.

FIG. 4 shows a curve of the read RF signal read from the recorded optical recording medium while the pickup head shown in FIG. 1 is in a specific focal distance.

FIG. 5 shows a curve of corresponding β values in accordance with different focus offset values of the calibration system shown in FIG. 1.

### DETAILED DESCRIPTION OF THE PREFERRED EMBODIMENT

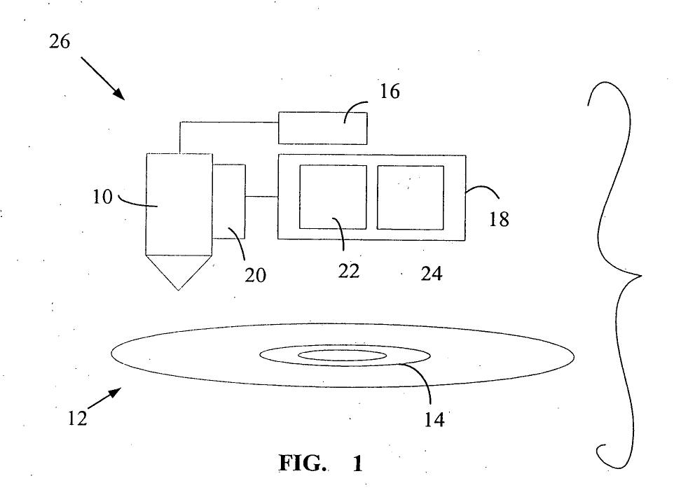

Please refer to FIG. 1. FIG. 1 is a schematic diagram of a calibration system 26 for calibrating focus positions of a pickup head 10 and an optical recording medium 12 according to the present invention. The pickup head 10 is in a focus position of a predetermined distance from an optical recording medium 12 for producing a recording light beam of a predetermined power for recording corresponding data onto the optical recording medium 12. The optical recording medium 12 comprises a power calibration area (PCA) 14. Before real recording is performed, the pickup head 10 performs an optimum power calibration (OPC) procedure in the PCA 14 for obtaining optimum recording power.

The calibration system 26 for calibrating focus positions of the pickup head 10 comprises a sensor 16, a controller 18, and a calibration actuator 20. The sensor 16 is used to sense a reflected light beam from the optical recording medium 12 and generate a corresponding write RF signal. The controller 18 comprises a position adjusting-module 22 and a searching module 24. The position adjusting module 22 can adjust the focus position of the pickup head 10 with a predetermined position adjustment procedure during data recording. The position adjustment procedure utilizes the calibration actuator 20 to actuate the pickup head 10 within a focusing range, so that the pickup head 10 records the data onto the PCA 14 in different focus positions in the focusing range.

The searching module 24 searches an extreme value of the write RF signal according to the write RF signal generated by the sensor 16, and obtains a corresponding-target focus position. The target focus position is the optimum focus position of the pickup head 10. The calibration actuator 20 controlled by the controller 18 adjusts the pickup head 10 to the target focus position, so as to enable further data recording onto the optical recording medium 12 by the pickup head 10 in the target focus position. After adjusting the pickup head 10 to the target focus position, the optimal power calibration (OPC) procedure is performed for controlling the power of the recording light beam of the pickup head 10.

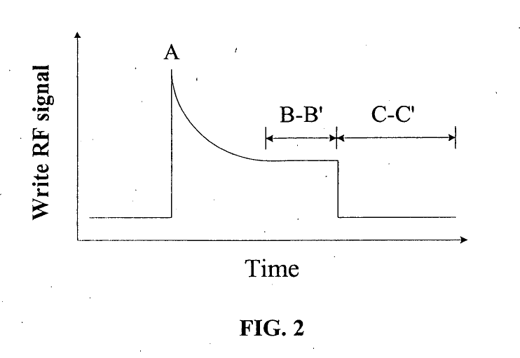

Please refer to FIG. 2. FIG. 2 is a schematic diagram of the write RF signals in the procedure of recording data onto the optical recording medium 12 when the pickup head 10 shown in FIG. 1 is in a specific focal distance. When the pickup head 10 proceeds with the procedure of recording data in a specific focal distance, the sensor 16 senses the reflected light beam from the optical recording medium 12 and generates a corresponding write RF signal. A change of the write RF signals with time is shown in FIG. 2. In FIG. 2, the point A is the corresponding write RF signal generated by the sensor 16 when the pickup head 10 starts emitting the recording light beam, wherein the write RF signal is called A level. Section B-B′ in FIG. 2 is a set of the corresponding write RF signals generated by the sensor 16 after the recording light beam emits for a while and becomes stable. Every point of section B-B′ is a corresponding write RF signal, and the intensity of these corresponding write RF signals is in a stable value, wherein the stable value is called B level. Section C-C′ is a set of the corresponding write RF signals generated by the sensor 16 while the pickup head stops its recording light beam and returns to its reproducing power, wherein the write RF signal is called C level.

In the calibration method of the present invention, the predetermined focus position of the pickup head 10 with respect to the optical recording medium 12 is defined as a focus error zero-crossing. Furthermore, a focus offset value based on the focus error zero-crossing is defined, wherein the focus offset value means the offset resulting from the pickup head 10 being more apart from or closed to the optical recording medium 12 based on the focus error zero-crossing.

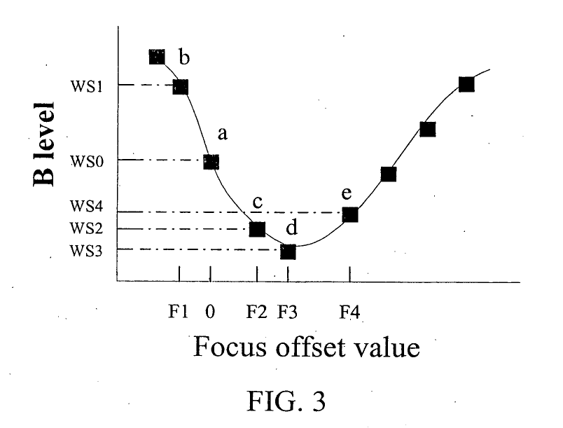

Please refer to FIG. 3. FIG. 3 shows a curve of corresponding B level in accordance with different focus offset values in the calibration system 26 shown in FIG. 1. According to the calibration method of the present invention, the optimum focus position is found to be the focus position corresponding to the minimal B level in different focus offset values. Followings are descriptions for finding out the minimal B level according to the calibration method of the present invention. In the process, the pickup head 10 uses the recording light beam with the predetermined power while it records data onto PCA 14, wherein the focus offset value of focus error zero-crossing is zero. First, the pickup head 10 records a datum with a focal distance of zero focus offset value, and the sensor 16 senses a reflected light beam from the optical recording medium 12 to generate a corresponding write RF signal. The point a in FIG. 3 represents the focal distance of zero focus offset value with its corresponding write RF signal at B level designated as WS0.

Next, the position adjusting module 22 of the controller 18 adjusts the focal distance of the pickup head 10 to a first offset value F1. The point b in FIG. 3 represents the first offset value F1 with its corresponding Write RF signal at B level designated as WS1. Next, the position adjusting module 22 adjusts the focal distance of the pickup head 10 again to a second offset value F2. The point c in FIG. 3 represents the second offset value F2 with its corresponding write RF signal at B level designated as WS2. Next, the position adjusting module 22 adjusts the focal distance of the pickup head 10 again to a third offset value F3. The point d in FIG. 3 represents the third offset value F3 with its corresponding write RF signal at B level designated as WS3. Next, the position adjusting module 22 adjusts the focal distance of the pickup head 10 again to a fourth offset value F4. The point e in FIG. 3 represents the fourth offset value F4 with its corresponding write RF signal at B level designated as WS4.

Because the searching module 24 determines that the point d is where the extreme value of write RF signal is within this error range, the focus position corresponding to the point d is the optimum focus position. Then, the calibration actuator 20 controlled by the controller 18 adjusts the pickup head 10 to the optimum focus position, so as to enable further data recording onto the optical recording medium 12 by the pickup head 10 in the optimum focus position.

In the calibration system 26 of the present invention, the searching module 24 has another function. After finishing data recording with the process described above, the pickup head 10 emits a reproducing light beam onto the optical recording medium 12 which has recorded data, and the sensor 16 senses the reflected reproducing light beam to generate a corresponding Read RF signal. The searching module 24 searches the extreme value of the read RF signal and obtains the optimum focus position corresponding to the searched extreme value of the Read RF signal.

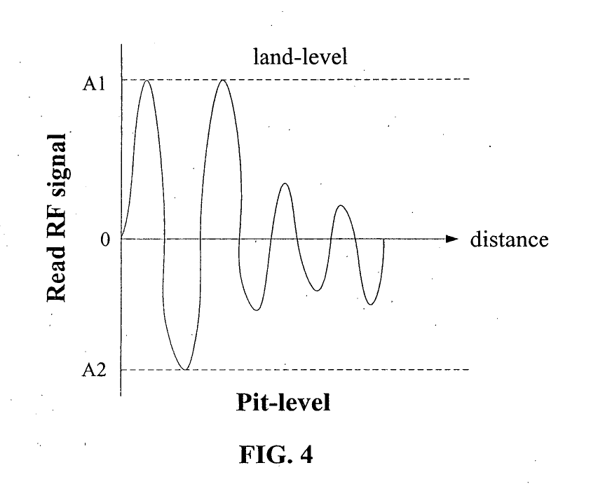

Please refer to FIG. 4. FIG. 4 shows a curve of the read RF signal read from the recorded optical recording medium 12 while the pickup head 10 shown in FIG. 1 is in a specific focal distance. The pickup head 10 emits a reproducing light beam onto the optical recording medium 12 that has recorded data, and the sensor 16 senses the reflected reproducing light beam to generate a corresponding read RF signal. Because the land-level and the pit-level on the recorded optical recording medium 12 are alternately and continuously arranged, the read RF signal continuously vibrates up and down passing through the zero point, as shown in FIG. 4. In FIG. 4, A1 is the maximal read RF signal and A2 is the minimal read RF signal. Define a β value according to A1 and A2 in FIG. 4, and the optimum focus position found by the calibration method of the present invention is the focus position corresponding to the maximal β value, wherein β is defined as:
β=(A1+A2)/(A1−A2)

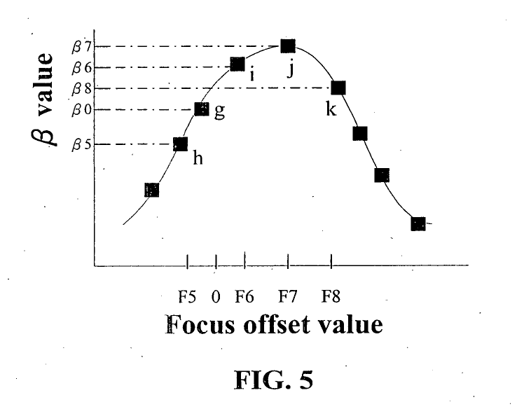

Please refer to FIG. 5. FIG. 5 shows a curve of corresponding β values in accordance with different focus offset values of the calibration system 26 shown in FIG. 1. In another calibration method of the present invention, the position adjusting module 22 of the controller 18 adjusts the focal distance of the pickup head 10 to the focal distances corresponding to zero offset value, a fifth offset value F5, a sixth offset value F6, a seventh offset value F7, and a eighth offset value F8, to record data onto the optical recording medium 12. After recording the data, the pickup head 10 in a predetermined focal distance emits a reproducing light beam to the data which is recorded with above-mentioned focal distances, respectively. The sensor 16 respectively senses the reflected reproducing light beams from the optical medium 12 to generate the corresponding read RF signals, and obtain the corresponding β values. The β values are designated as β0, β5, β6, β7, and β8 in respect to the zero offset values, F5, F6, F7, and F8. And g, h, i, j, and k points in FIG. 5 represent the β values corresponding to the offset values. Because the point j is where the extreme value of read RF signal is, determined by the searching module 24, the focus position corresponding to the point j is the optimum focus position for recording. Then, the calibration actuator 20 controlled by the controller 18 adjusts the pickup head 10 to the optimum focus position, so as to enable further data recording onto the optical recording medium 12 by the pickup head 10.

To compare with the prior art method directly using focus error zero-crossing for calibrating focus positions of a pickup head only for reproducing data , the calibration method of the present invention is to find out the optimum recording focus position of the pickup head 10 before the OPC procedure is performed. The optimum recording focus position is searched in accordance with the β value or B level, which directly relates to recording quality. Thus the calibration method of the present invention can ensure stable recording and reproducing quality.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1-10. (canceled)

11. A calibration method for calibrating focus positions of a pickup head, the pickup head being in a focus position of a predetermined distance from an optical recording medium for producing a recording light beam of a predetermined power for recording corresponding data onto the optical recording medium, the calibration method comprising the following steps:
utilizing a predetermined position adjustment procedure to adjust the focus position of the pickup head for performing data recording on the optical recording medium, and when finishing data recording, emitting a light beam onto the optical recording medium for sensing a reflected light beam therefrom by means of a sensor to generate a corresponding Read RF signal;
searching a extreme value of the read RF signal and obtaining a target focus position corresponding to the searched extreme value of the read RF signal; and
adjusting the pickup head to the target focus position, so as to enable further data recording onto the optical recording medium by the pickup head in the target focus position.

12. The calibration method of claim 11, wherein when the calibration method accomplished, a optimal power calibration (OPC) procedure is performed for controlling the power of the recording light beam of the pickup head.

13. The calibration method of claim 11, wherein the predetermined focus position of the pickup head with respect to the optical recording medium defines a focus error zero-crossing.

14. The calibration method of claim 11, wherein the optical recording medium comprises a power calibration are (PCA), and in the calibration method, the pickup head records the data for calibration in the PCA.

15. The calibration method of claim 11, wherein the position adjustment procedure utilizes an calibration actuator to actuate the pickup head within a focusing range, so that the pickup head records the data onto the PCA in different focus positions in the focusing range.

16. A calibration system for calibrating focus positions of a pickup head, the pickup head being in a focus position of a predetermined distance from an optical recording medium for producing a recording light beam of a predetermined power for recording corresponding data onto the optical recording medium, the calibration system comprising:
a sensor, for sensing a reflected light beam from the optical recording medium;
a controller, comprising:
a position adjusting module, capable of adjusting the focus position of the pickup head with a predetermined position adjustment procedure during data recording;
a searching module, when finishing data recording, the pickup head emitting a light beam onto the optical recording medium, and the sensor sensing the reflected light beam therefrom to generate a corresponding read RF signal, wherein the searching module searches a extreme value of the Read RF signal and obtaining a target focus position corresponding to the searched extreme value of the read RF signal; and
a calibration actuator, controlled by the controller, for adjusting the pickup head to the target focus position, so as to enable further data recording onto the optical recording medium by the pickup head in the target focus position.

17. The calibration system of claim 16, wherein after adjusting the pickup head to the target focus position, a optimal power calibration (OPC) procedure is performed for controlling the power of the recording light beam of the pickup head.

18. The calibration system of claim 16, wherein the predetermined focus position of the pickup head with respect to the optical recording medium defines a focus error zero-crossing.

19. The calibration system of claim 16, wherein the optical recording medium comprises a power calibration are (PCA), and the pickup head records the data for calibration in the PCA.

20. The calibration system of claim 19, wherein the position adjustment procedure utilizes an calibration actuator to actuate the pickup head within a focusing range, so that the pickup head records the data onto the PCA in different focus positions in the focusing range.
